(19) United States
(12) Patent Application Publication
(10) Pub. No.: US 2026/0003901 A1
(43) Pub. Date: Jan. 1, 2026

(54) SYSTEM AND METHOD FOR NATURAL LANGUAGE PROCESSING AT AN EDGE DEVICE

(71) Applicant: Booz Allen Hamilton Inc., Mclean, VA (US)

(72) Inventors: Daniel Wald, Melbourne, FL (US); Philip Collin Richard Navarro Paran, Denver, CO (US); Eric Robert Willis, Alexandria, VA (US); Nathan David Zameroski, Colorado Springs, CO (US)

(73) Assignee: Booz Allen Hamilton Inc., Mclean, VA (US)

(21) Appl. No.: 19/253,431

(22) Filed: Jun. 27, 2025

Related U.S. Application Data
(60) Provisional application No. 63/665,596, filed on Jun. 28, 2024.

(51) Int. Cl. G06F 16/334; G06N 3/0475

(52) U.S. Cl. CPC G06F 16/3344; G06N 3/0475

(57) ABSTRACT

Exemplary system and methods for processing a natural language query in an edge computing system are disclosed. A processor of the computing system receives a natural language textual input as a query from a user interface and receives one or more containers of documentation over a communication channel. The processor generates a query embedding vector from the textual input. The processor extracts text from the received container and generates text chunks of specified length from the extracted data. Text embeddings are generated from the text chunks and stored in memory for a specified period. The query embeddings are compared with the text embeddings to determine relevant context information. The processor passes the relevant context information and the query through a trained neural network to generate a response. The response generated by the trained neural network is formatted and output to a user interface.

### FIELD

The subject matter disclosed relates generally to natural language processing, and more particularly to system and methods that perform natural language processing at the edge using a large language model.

### BACKGROUND

Retrieval-augmented generation (RAG) models are a recent development in natural language processing (NLP) that combines the capabilities of retrieval systems and language models for improved Q/A and text generation tasks. Currently, known systems use large-scale RAG models, such as large LLMs (including GPT and Claude) and vector databases for storage of large document sets. These applications tend to focus on open-domain question answering, multi-step reasoning, and efficient retrieval techniques.

Space missions involve complex and data-intensive operations that can benefit from advanced AI capabilities. Large language models (LLMs) require substantial computational resources, which are typically not feasible for space missions due to limitations in size, weight, and power consumption. The use of networkable LLMs enables distributed processing and improved coordination at the edge of space, further enhancing mission capabilities. Additionally, the system is designed to operate in contested and non-internet connected environments, ensuring robustness and reliability in various challenging scenarios.

### SUMMARY

An exemplary edge computing system is disclosed, comprising memory configured for storing programming code for executing one or more application module and a trained neural network for processing natural language queries for a specified data domain, and storing data associated with the specified data domain; at least one processor configured to execute the programming code stored in non-volatile memory and generate: an input module configured to receive a natural language textual input as a query from a user interface; an embedding module configured to generate a query embedding vector from the textual input; the input module being further configured to receive one or more containers of documentation over a communication channel; an extraction module configured to extract text from the one or more containers and generating text chunks of specified length from the extracted data; the embedding module being further configured to generate text embeddings from the text chunks and store the text embeddings in the memory for a specified period; a similarity search module configured to compare the query embeddings with the text embeddings to determine relevant context information; a trained neural network configured to receive the relevant context information and the query and generate a response; and an output module configured to format and output the response generated by the trained neural network to the user interface.

An exemplary method for processing natural language queries for a specified data domain in an edge computing system is disclosed, the method comprising: receiving, by a processor of the computing system, a natural language textual input as a query from a user interface and one or more containers of documentation over a communication channel; generating, by the processor, a query embedding vector from the textual input; extracting, by the processor, text from the one or more containers and generating text chunks of specified length from the extracted data; generating, by the processor, text embeddings from the text chunks and store the text embeddings in memory for a specified period; comparing, by the processor, the query embeddings with the text embeddings to determine relevant context information; passing, by the processor, the relevant context information and the query through a trained neural network to generate a response; and formatting and outputting, by the processor, the response generated by the trained neural network to the user interface.

An exemplary non-transitory computer readable medium is disclosed, the computer readable medium being encoded with program code for generating one or more application modules and a neural network for processing a natural language query, and when placed in communicable contact with an edge computing device, the computer readable medium configures the edge computing system to: receive, by a processor of the computing system, a natural language textual input as a query from a user interface and one or more containers of documentation over a communication channel; generate, by the processor, a query embedding vector from the textual input; extract, by the processor, text from the one or more containers and generating text chunks of specified length from the extracted data; generate, by the processor, text embeddings from the text chunks and store the text embeddings in memory for a specified period; compare, by the processor, the query embeddings with the text embeddings to determine relevant context information; pass, by the processor, the relevant context information and the query through a trained neural network to generate a response; and format and output, by the processor, the response generated by the trained neural network to the user interface.

### DESCRIPTION OF THE DRAWINGS

Exemplary embodiments are best understood from the following detailed description when read in conjunction with the accompanying drawings. Included in the drawings are the following figures:

FIG. 1 illustrates a system for natural language processing at an edge device according to an exemplary embodiment of the present disclosure.

FIG. 2 illustrates a neural network architecture for an LLM according to an exemplary embodiment of the present disclosure.

FIG. 3 illustrates a hardware configuration of a computing device for natural language processing at an edge device according to an exemplary embodiment of the present disclosure.

FIG. 4 is a block diagram illustrating a processor configured for processing a natural query at an edge device according to an exemplary embodiment of the present disclosure.

FIG. 5 illustrates a method for processing natural language queries for a specified data domain in an edge computing system according to an exemplary embodiment of the present disclosure.

FIG. 6 illustrates a system for processing natural language queries for a specified data domain at the edge according to an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

Exemplary systems and methods of the present disclosure utilizing large language models (LLMs) in space environments, deep sea or subsurface environments, contested environments, and/or non-internet connected environments are disclosed. Exemplary embodiments can be implemented through retrieval-augmented generation (RAG) and can enable a user to efficiently query and retrieve relevant information from a corpus of instruction manuals and procedural documentation using natural language queries. The disclosed exemplary embodiments leverage state-of-the-art language model techniques while being designed and containerized (e.g., compressed, encrypted, executable file) to run reliably on the resource-constrained computing environments operating at the edge in contested and non-internet connected environments such as outer space. The edge computing system and methods described herein can be configured for resource-constrained deployment, which provides a significant advancement in deploying RAG models in extreme (low power, high radiation) environments, such as outer space, with limited computational resources. The exemplary computing systems and methods can be implemented for a highly specialized domain and use case, such as instruction and operating manuals for a spaceborne vehicle (e.g., International Space System) or vehicle designed for operation in an extreme environment such as a deep sea or deep subsurface environment. In addition, according to exemplary embodiments of the present disclosure, LLMs can be deployed on edge computing devices, embedded systems, connected for communication, and distributed processing in a mesh network absent an Internet connection, traditional data center, or cloud environment.

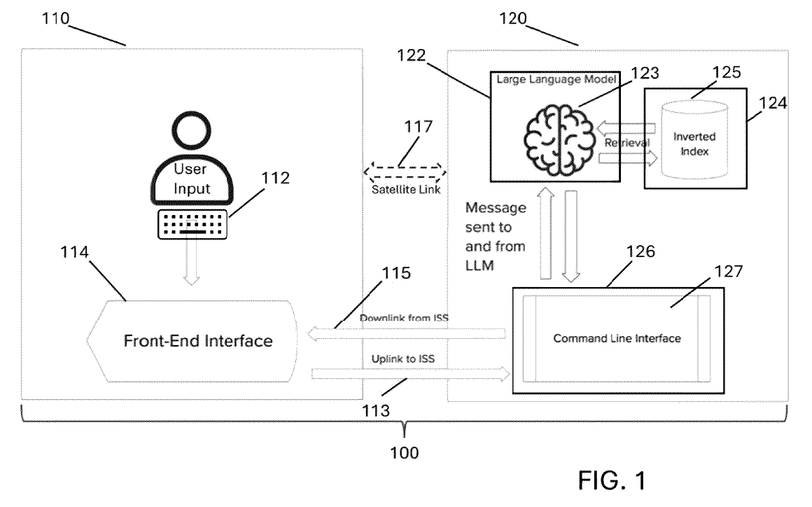

FIG. 1 illustrates a system for natural language processing at an edge device according to an exemplary embodiment of the present disclosure. According to an exemplary embodiment, the system 100 can include a user computing device 110 and an edge computing system 120 configured to operate at the edge, where the location of the edge is defined as a resource-constrained computing environment. With respect to the resource-constrained environment, the edge computing system 120 can be deployed on a vehicle or other suitable transport entity or device, where computing resources are constrained based on size, weight, and power (SWaP) requirements. In addition, the resource-constrained computing environment can be limited in that there are no resources available for connecting to a local or wide area network where data and/or information can be stored or accessed by a deep learning neural network (DLNN) or large language model (LLM). For example, the edge device can be configured for deployment on a human or robot, an orbiting satellite, space station, lunar or interplanetary vehicle, deep sea vehicle, deep subsurface vehicle, or any other vehicle operating in an environment with structural limitations due to SWAP requirements including the unavailability of a data communication network or undesirability of connecting to a data communication network.

According to an exemplary embodiment, the edge device can be configured as a wearable device (e.g., body-worn, body-mounted, etc.), a device arranged in a package that can be detachably mounted or attached to a vehicle or moveable system, a device arranged in a package that can be integrated into the housing of a vehicle or moveable system, a device having components and/or packaging that can be integrated into the circuitry of a vehicle or movable system, or any other suitable configuration or construct as desired.

The user computing device 110 can be a processing device such as a smart phone, laptop computer, desktop computer, tablet, or other personal computing device that is configured to execute instructions and/or programming code for generating a query. The user computing device 110 can include a combination of hardware and software components 112 for receiving a user input. For example, the user computing device 110 can include a microphone, physical keyboard, virtual keyboard, and associated software interface, or any other suitable device and/or components for receiving a user input for generating the query. The user input can be configured to include a front-end interface 114 that can perform plural operations on the user input, such as, parse the user's input (e.g., a question, a phrase) to understand its intent and identify relevant keywords and entities. Based on the understanding of the user's intent and context, the front end interface 114 can construct a formal query (e.g., SQL, PPL). The user computing device 110 and the edge computing device 120 can be connected via wireless communication system suitable for sending and receiving data to and from the resource-constrained computing environment. The user computing device 110 can be configured with hardware and software components for radio communications with the edge computing device 120. According to an exemplary embodiment, the user computing device 110 can be configured as a ground-based system for sending information (e.g., data, commands, etc.) from Earth (e.g., above-ground, sea-level, etc.) to the edge computing device 120 through an uplink 113 and receiving data from the edge computing device 120 through a downlink 115. According to another exemplary embodiment, the user computing device 110 can be configured as a space-, sub-oceanic, or sub-terraneous-based system that is located on a vehicle (e.g., spacecraft or other suitable vehicle for the environment) that is different from the vehicle or entity on which the edge computing device 120 is deployed. In a space-based configuration, for example, the user computing device 110 can transmit and/or receive information to/from the edge computing device 120 through a satellite link (e.g., crosslink) 117.

The edge computing device 120 can be configured to include at least a processor 122, memory 124, and a communications interface 126 suitable for operation in the resource-constrained environment as already discussed. As shown in FIG. 1, the processor 122 can be configured to execute programming code and/or instructions for performing operations for natural language processing at the edge. For this purpose, the programming code and/or instructions can cause the processor 122 to generate at least a trained large language model (LLM) 123. According to an exemplary embodiment, the processor 122, memory 124, and communications interface 126 can be arranged in a package configured according to SWaP specifications of a specified resource-constrained environment.

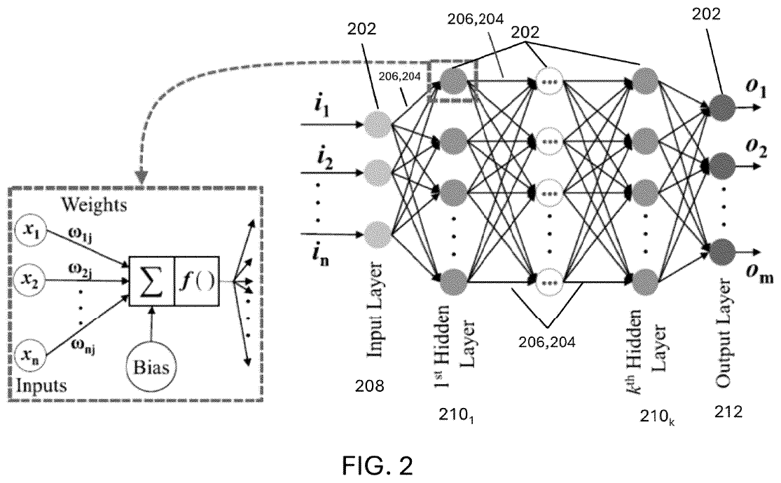

FIG. 2 illustrates a neural network architecture for an LLM according to an exemplary embodiment of the present disclosure. As shown in FIG. 2, the trained LLM can use one or more deep learning (DL) neural network architectures 200. The neural network(s) 200 can include plural nodes 202 that represent individual computational units. Each node has one or more biased input/output connections that function as transfer or activation functions for combining the inputs and outputs in a specified manner. The neural network can include plural nodes, where each node has one or more inputs 204 and outputs 206 for processing the textual input. The neural network can be formed by an arrangement of the plural nodes 202 into multiple layers, the scheme within which the nodes are connected determines the type and operation of the neural network. For example, the neural network can include an input layer 208, multiple hidden layers 210ₖ, and an output layer 212. Each layer may perform a different or specified transformation on the respective inputs, using a different or specified mathematical calculation or function. Signals travel or are passed between the layers, from the input layer to the output layer via the middle or hidden layers and can traverse any layer and node(s) multiple times. The nodes 202 can be connected in an array and each node can transmit a signal to a node 202 in another layer of the neural network. The input/output (204, 206) connections between the nodes 202 have a corresponding weight wₙⱼ and are combined according to the bias applied at each node. For example, the connections are activation or transfer functions which trigger the respective nodes and combine inputs according to mathematical equations or formulas according to the bias.

According to an exemplary embodiment, the processor 122 can be configured for training machine learning and/or artificial intelligence models (e.g., neural models, neural networks, and/or the like) for processing a natural language query at the edge. For example, the LLM 123 can be trained using the data and/or information provided in the container(s) prior to deployment to the resource-constrained environment (e.g., the edge).

As shown in FIG. 1, the memory 124 of the edge computing device 120 can be configured to include an inverted index 125 for use by the LLM 123. The inverted index 125 can store a mapping between terms (words or other tokens) and the documents (or other data objects) where those terms appear. For example, the inverted index 125 includes tokens which represents text that is sectioned into words or phrases. The processor 122 can be configured to create a list of a list of documents identifiers (e.g., metadata) for each term stored in the inverted index 125. The document identifiers are also stored in the inverted index 125. As a result, the inverted index 125 is used for looking up query terms and retrieving a corresponding list of documents. The communications interface 126 can include a combination of hardware and software components for communicating with the user computing device 110 over the uplink 113 and downlink 115. According to an exemplary embodiment, the communications interface can include a command line interface 127 through which a query received from the user computing device 110 is formatted and used to interact with the inverted index 125 stored in memory 124 via the LLM 123 executed by the processor 122.

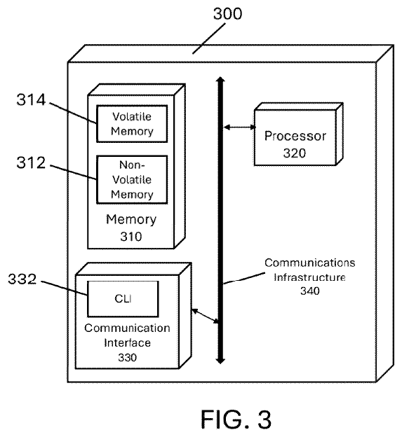

FIG. 3 illustrates a hardware configuration of a computing device for natural language processing at an edge device according to an exemplary embodiment of the present disclosure. As shown in FIG. 3, the computing device 300 can include memory 310, a processor 320, and a communications interface 330. The memory 310 can include a non-volatile memory 312 configured for storing programming code and/or instructions for executing plural application modules and the trained neural network 123 for processing natural language queries for a specified data domain, and volatile memory 314 configured for storing data associated with the specified data domain. The non-volatile memory 312 can include read-only memory (ROM), Read Only Memory (ROM), Programmable Read only Memory (PROM), Erasable Programmable Read only Memory (EPROM), Electronically Erasable Programmable Read only Memory (EEPROM), and FLASH-EPROM. The volatile memory 314 may include random access memory (RAM). The volatile 314 and/or non-volatile memory 312 can include dynamic or static storage device (e.g., flash memory, magnetic memory, optical memory, etc.) that stores information and/or software instructions for use by the processor. Memory 310 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices. The non-transitory computer readable medium can include a Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor

The processor 320 may be implemented in hardware, software, or a combination of hardware and software. For example, the processor 320 may include a common processor (e.g., a CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform the operations disclosed herein. The processor 320 can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor 320.

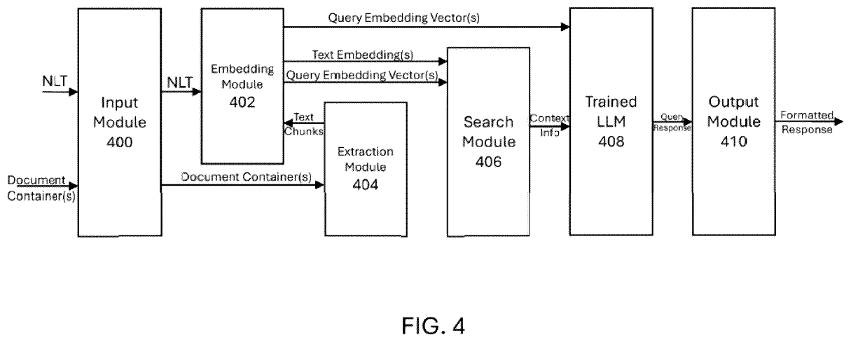

FIG. 4 is block diagram illustrating a processor configured for processing a natural query at an edge device according to an exemplary embodiment of the present disclosure.

The exemplary system and methods of the present disclosure can be implemented using a number and arrangement of systems, hardware, and/or modules (e.g., software instructions). For example, the system can be a combination of two or more systems, hardware, and/or modules or may be implemented within a single system, hardware, and/or module. A single system, hardware, and/or module may be implemented as multiple, distributed systems, hardware, and/or modules. Additionally, or alternatively, a set of systems, a set of hardware, and/or a set of modules (e.g., one or more systems, one or more hardware devices, one or more modules) may perform one or more functions described as being performed by another set of systems, another set of hardware, or another set of modules.

According to an exemplary embodiment, the programming code when executed causes the processor 320 to generate one or more application module and a neural network, such as an input module 400, an embedding module 402, an extraction module 404, a search module 406, a pre-trained LLM 408, and an output module 410. The input module 400 can be configured to receive a natural language textual input as a query and one or more containers of documentation over a communication channel, such as the uplink 113. As already discussed, the natural language textual input can be generated at the user computing device 110 and the one or more containers of documentation can be received from a ground-based command station. The command station can be disposed at a ground-based location that is different from the user computing device 110. Each of the user computing device 110 and the command station are in a location that is outside of the resource constrained computing environment. According to an exemplary embodiment, the computing system can be deployed on a spaceborne vehicle orbiting Earth and the command station can be located at a facility or location on Earth. According to another exemplary embodiment, the computing system can be deployed on a deep sea or deep subsurface vehicle and the command station can be located at an above ground level location.

The embedding module 402 can be configured to generate a query embedding vector from the textual input. The extraction module 404 can be configured to extract text from the container input and generate text chunks of specified length from the extracted text. The embedding module 402 can be further configured to generate text embeddings from the text chunks and store the text embeddings in the volatile memory 314. A search module 406 can be configured to compare the query embeddings with the text embeddings to determine similar and relevant context information. The trained LLM 408 can be configured to receive the relevant context information from the search module 406 and the query embeddings from the embedding module 402 and generate a response. For example, the LLM can use the relevant context information and the query embeddings with the inverted index 125 to look up query terms and retrieve a corresponding list of documents from the container. The output module 410 can be configured to format the response generated by the trained neural network and output the formatted response to the user computing device 102 using the communications interface 330.

The exemplary system can also include a communications interface 330. The communications interface can be configured to allow software and data to be transferred between the computing device and external devices. Exemplary communications interfaces can include a modem, a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

The communications interface 330 can include a receiver or receiving device may be a combination of hardware and software components configured to receive data from the user computing device 110 or command center. According to exemplary embodiments, the receiving device can include a hardware component such as an antenna, a communications port, a Personal Computer Memory Card International Association (PCMCIA) slot and card, 5G New Radio (NR) interface, or any other component or device suitable for use on a mobile communication network or Radio Access Network as desired. The receiving device can be an input device for receiving signals and/or data samples formatted according to 3GPP protocols and/or standards. The receiving device can be connected to other devices via a wired or wireless network or via a wired or wireless direct link or peer-to-peer connection without an intermediate device or access point. The hardware and software components of the receiving device can be configured to receive the data from the mobile network according to one or more communication protocols and data formats. For example, the receiving device can be configured to communicate over a network including for example, a mesh network, a wireless network (e.g., Wi-Fi), a mobile communication network, a satellite network, fiber optic cable, coaxial cable, infrared, radio frequency (RF), another suitable communication medium as desired, or any combination thereof. During a receive operation, the receiving device can be configured to identify parts of the received data via a header and parse the data signal and/or data packet into small frames (e.g., bytes, words) or segments for further processing at the processor.

The communications interface 330 can also include a transmitter or transmitting device configured to receive data from the processor and assemble the data into a data signal and/or data packets according to the specified communication protocol and data format of the communication link for receipt by the user computing device 110 and/or the command center. The transmitting device can include any one or more of hardware and software components for generating and communicating the data signal over the communications infrastructure and/or via a direct wired or wireless link to a peripheral or remote device. The transmitting device can be configured to transmit information according to one or more communication protocols and data formats as discussed in connection with the receiving device.

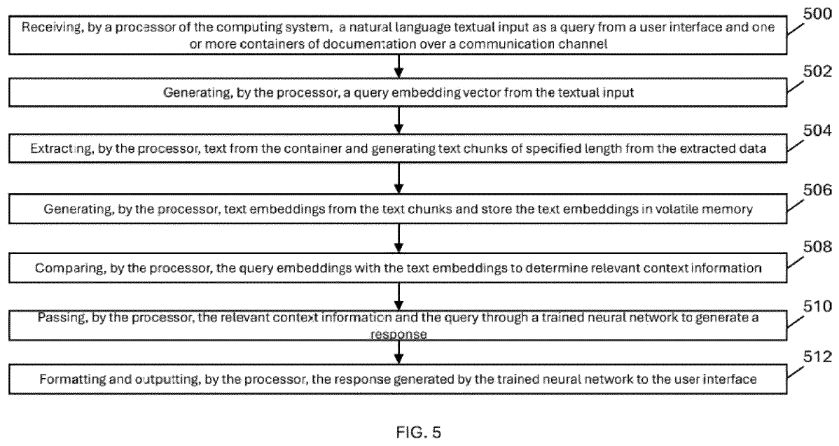

FIG. 5 illustrates a method for processing natural language queries for a specified data domain in an edge computing system according to an exemplary embodiment of the present disclosure.

The method is performed by the edge computing device 120 while being deployed or disposed in a resource constrained environment. In step 500, the method involves receiving, by a processor 122 of the edge computing device 120, a natural language textual input as a query from a user interface and one or more containers of documentation over a communication channel 113. The textual input can be received over a communication link 113 from a user computing device 110 and the one or more containers can be received over the communication link 113 from a ground-based command center. The processor 122 generates a query embedding vector from the textual input (Step 502) and extracts text from the one or more containers and generating text chunks of specified length from the extracted data (Step 504). In Step 506, the processor 122 generates text embeddings from the text chunks and store the text embeddings in volatile memory 314 for a specified period of time, such as until text embeddings for a subsequent search are generated or the memory is reset. The processor 122 compares the query embeddings with the text embeddings to determine relevant context information (Step 508) and passes the relevant context information and the query through a trained neural network 123 to generate a response to the query (Step 510). Step 512 involves the processor 122 formatting and outputting the response generated by the trained neural network to the user interface.

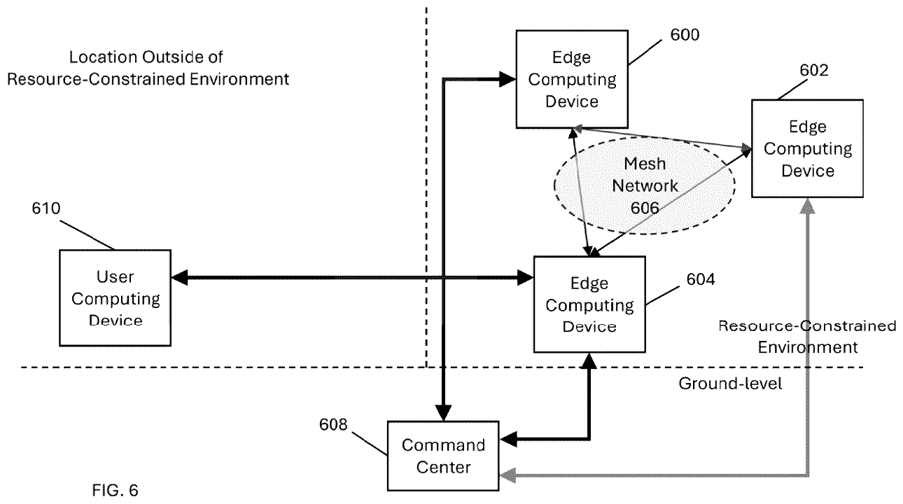

FIG. 6 illustrates a system for processing natural language queries for a specified data domain at the edge according to an exemplary embodiment of the present disclosure. According to an exemplary embodiment, multiple or plural edge computing devices 600, 602, 604 (e.g., edge computing systems) as described herein can be connected in a mesh network 606. The input module of each computing system in the mesh network can be configured to ingest a container containing documentation related to different data domains. For example, a first edge computing device 604 in the mesh network 606 can ingest a container sent from a command center 608 having documentation related to the repair or maintenance of one or more on-board components or systems of the vehicle. A second edge computing device 602 in the mesh network 606 can ingest another container having documentation related to injury and/or medical treatment and diagnosis. Each edge computing devices 600, 602, 604 in the mesh network 606 can receive a mapping of the specified data domain associated with every other edge computing device connected to the mesh network. According to an exemplary embodiment, each edge computing device 600, 602, 604 can be configured to broadcast a request over the mesh network 606 for identifying another edge computing device 600, 602, 604 connected to the network 606 having a container related to a specified data domain. Through the mesh network 606, a natural language query received from a user computing device 610 can be processed in a distributed and collaborative scheme where each edge computing device 600, 602, 604 can send a request to any other edge computing device connected to the mesh network 606 having a container specifically tailored, on account of the data domain, for processing at least a portion of the natural language query received from the user computing device 610. The edge computing device can process the portion of the natural language query and send the generated response to the requesting edge computing device.

The exemplary system described herein can be implemented in a configuration suitable for natural language query processing at an edge location as disclosed herein. For example, various components of the system may be implemented in one or more computing devices (e.g., one or more servers, client devices, user devices, and/or the like) according to a specified role and the one or more computing devices may be connected via a suitable communications network for the resource-constrained environment.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. An edge computing system, comprising:
memory configured for storing programming code for executing one or more application module and a trained neural network for processing natural language queries for a specified data domain, and storing data associated with the specified data domain;
at least one processor configured to execute the programming code stored in memory and generate:
an input module configured to receive a natural language textual input as a query from a user interface;
an embedding module configured to generate a query embedding vector from the textual input;
the input module being further configured to receive one or more containers of documentation over a communication channel;
an extraction module configured to extract text from the one or more containers and generating text chunks of specified length from the extracted data;
the embedding module being further configured to generate text embeddings from the text chunks and store the text embeddings in the memory for a specified period;
a similarity search module configured to compare the query embeddings with the text embeddings to determine relevant context information;
a trained neural network configured to receive the relevant context information and the query and generate a response; and
an output module configured to format and output the response generated by the trained neural network to the user interface.

2. The system according to claim 1, wherein the one or more containers includes plural containers, and each container containing documentation relevant to a specified data domain.

3. The system according to claim 2, wherein each of the at least one processor is configured to execute a trained neural network according to the specified data domain of the container.

4. The system according to claim 3, wherein the at least one processor includes plural processors are connected in a mesh network, and each such connected processor is configured to communicate with at least one other processor in the mesh network to generate at least a portion of the response to the query.

5. The system according to claim 4, wherein a first processor in the mesh network is configured to send at least part of a received query to a second processor in the mesh network to generate the response to the query.

6. The system according to claim 1, wherein the documentation in the container includes pdf documents.

7. The system according to claim 6, wherein the extraction module is configured to extract text from the pdf documents using a pdf reader.

8. The system according to claim 1, wherein the similarity search module is configured to compare query embeddings with the text embeddings using a cosine similarity computation.

9. The system according to claim 1, wherein the trained neural network is a large language model.

10. The system according to claim 9, wherein the trained neural network is configured for Retrieval Augmented Generation.

11. The system according to claim 1, wherein the input module includes a user interface and a non-internet network interface.

12. The system according to claim 1, wherein the memory includes volatile memory for storing text embeddings.

13. The system according to claim 1, further comprising:
packaging configured for deployment in a resource-constrained environment,
wherein the non-volatile memory, volatile memory, and the at least one processor are included in the packaging.

14. The system according to claim 13, wherein the packaging is configured as a wearable device.

15. The system according to claim 1 being arranged as a wearable device.

16. A method for processing natural language queries for a specified data domain in an edge computing system, the method comprising:
receiving, by at least one processor of the computing system, a natural language textual input as a query from a user interface and one or more containers of documentation over a communication channel;
generating, by the at least one processor, a query embedding vector from the textual input;
extracting, by the at least one processor, text from the container and generating text chunks of specified length from the extracted data;
generating, by the at least one processor, text embeddings from the text chunks and store the text embeddings in memory for a specified period;
comparing, by the at least one processor, the query embeddings with the text embeddings to determine relevant context information;
passing, by the at least one processor, the relevant context information and the query through a trained neural network to generate a response; and
formatting and outputting, by the at least one processor, the response generated by the trained neural network to the user interface.

17. The method according to claim 16, wherein the at least one processor includes plural processors, the method further comprising:
executing, by each processor, a trained neural network according to the specified data domain of the container.

18. The method according to claim 17, wherein the plural processors are connected in a mesh network, the method further comprising:
communicating, by each processor, with at least one other processor connected to the mesh network to generate the response to the query.

19. The method according to claim 18, wherein the plural processors include a first processor and a second processor, the method comprising:
sending, by the first processor, at least part of a received query to the second processor for processing the querying and generating a response.
sending, by the second processor, the generated response to the first processor.

20. A non-transitory computer readable medium encoded with program code for generating one or more application modules and a neural network for processing a natural language query, the computer readable medium when placed in communicable contact with an edge computing device, configures the edge computing system to:
receive, by a processor of the computing system, a natural language textual input as a query from a user interface and one or more containers of documentation over a communication channel;
generate, by the processor, a query embedding vector from the textual input;
extract, by the processor, text from the container and generating text chunks of specified length from the extracted data;
generate, by the processor, text embeddings from the text chunks and store the text embeddings in memory for a specified period;
compare, by the processor, the query embeddings with the text embeddings to determine relevant context information;
pass, by the processor, the relevant context information and the query through a trained neural network to generate a response; and
format and output, by the processor, the response generated by the trained neural network to the user interface.
